(19) United States
(12) Patent Application Publication
(10) Pub. No.: US 2011/0042864 A1
(43) Pub. Date: Feb. 24, 2011

(54) Method for Making a Flexible Pouch

(75) Inventor: Jean-Paul Naef, La Frette (FR)

Correspondence Address: DALY, CROWLEY, MOFFORD & DURKEE, LLP, SUITE 301A, 354A TURNPIKE STREET, CANTON, MA, 02021-2714, US

(73) Assignee: European Company of Study and Research for Devices for the Implantation by Laparoscopy, Vienne (FR)

(21) Appl. No.: 12/919,882

(22) PCT Filed: Feb. 27, 2009
(86) PCT No.: PCT/FR09/50330

§ 371 Date: Nov. 10, 2010

(30) Foreign Application Priority Data
Feb. 28, 2008 (FR) FR-08 01114

(51) Int. Cl. B29C 41/04; B29C 41/06

(52) U.S. Cl. 264/503; 264/114; 264/311; 425/435; 425/429

(57) ABSTRACT

The invention relates to a method for making a flexible pouch, said method being characterized in that it comprises: the step of inserting (a) at least one fluid or powdery material into a hollow mould (3) having an inner wall (3A), said inner wall (3A) defining a closed moulding surface; the step of rotating (b) the mould (3) in order to spread the material substantially against the entire inner wall (3A) of the mould (3) by centrifuging. The invention can be used for flexible containers.

### TECHNICAL FIELD

The present invention relates to the overall technical field of the manufacture of containers that can be used particularly in a medical or agri-foodstuffs environment to contain, for example, a foodstuff or a fluid.

The present invention relates in particular to the manufacture of flexible containers able, for example, to deform when stress is applied.

The present invention relates to a method of manufacturing a flexible pouch.

### PRIOR ART

As part of the treatment of morbid obesity in man, it is known practice to insert a gastric balloon into the stomach of a patient in order to occupy some of the internal volume of the stomach with a view to restricting the space available for ingested food.

This gastric balloon is generally introduced into the stomach in folded and deflated form via the natural passages of man, that is to say via the mouth and then the esophagus. Having introduced the balloon into the stomach, the surgeon injects an inflation fluid to inflate the balloon until it reaches a functional service volume that will be effective in treating the patient. Inflating the gastric balloon makes it possible to reduce substantially the flow of foodstuff ingested into the stomach in such a way that the patient begins to feel full quite quickly and thus limits his food intake.

The balloon is often made up of a flexible pouch manufactured in an elastomeric material compatible with the human and/or animal body and, in particular, with the stomach environment. The flexible pouch of the gastric balloon is intended to receive the inflation fluid, for example air, which allows it to expand from a deflated configuration to a functional inflated configuration. Thus, it is appropriate for the flexible pouch to be sufficiently expandable that it can be expanded from a deflated folded position to an expanded inflated position.

In general, the flexible pouch is made of a biocompatible elastomer, for example of a silicone or of a polyurethane.

There are several known ways of manufacturing the flexible pouch of the gastric balloon.

One of these methods is the dip technique which involves dipping a core, of a determined shape conforming to the desired shape of the balloon (for example of a spherical, ovoid or ellipsoid shape) into a bath of silicone dispersed in a solvent. This technique then involves a step of drying the film formed at the surface of the core by this dipping operation, followed by a step of releasing the core from the mold so as to obtain a flexible silicone pouch.

Such a method of manufacture, while satisfactory, does nonetheless have a number of disadvantages.

Specifically, this method involves the use of a particularly toxic solvent, the handling of which involves the taking of a great many precautions, both toward the operator and also toward the equipment and the environment.

Further, the dip method requires special skill and has to be carried out by specialist qualified operators. The problem is that this method requires constant monitoring and supply of solvent, particularly to control the fluidity of the dip bath. It is therefore a method which is particularly awkward to implement.

Moreover, the dip method often involves several dip states in order to build up the desired pouch thickness. This peculiarity of the method has a tendency to make it even more burdensome to implement, especially since the operator has to wait until the solvent has completely evaporated between steps in order to ensure that the deposited layer has crosslinked. Hence, the dip method is particularly lengthy and it generally takes about half a day to obtain one gastric balloon. Further, recourse to a multi-layer coating to form the pouch of the balloon may also lead to a lack of cohesion between certain layers, and this lack of cohesion may have not-insignificant consequences on the intactness of the balloon and its use in the stomach of the patient.

On top of this, the dip method does not allow effective monitoring and control over the thickness of the flexible pouch. Indeed this method may lead to localized excess thicknesses which may make the balloon heavier and increase its cost of production. On the other hand, such a method may just as easily give rise to regions of lesser thickness which may weaken the balloon in use.

It is also known practice to produce a flexible pouch using a high-frequency welding method, for example to manufacture a flexible pouch made of polyurethane. In this method, the flexible pouch is formed by joining together flexible sheets of polyurethane that have been superimposed and joined together along a high-frequency weld line at their interface.

This technique has the benefit of guaranteeing that the flexible pouch obtained will be of smaller thickness than can be obtained using the dip method. This method is also easier to implement and particularly cost-effective.

However, this method has its disadvantages also, particularly in terms of its implementation. Specifically, if the flexible pouch is to receive a surface treatment, then the high-frequency welding step generally dictates that the operations of the method be performed in a precise order, and, in particular, that the treatment be applied after the high-frequency welding operation.

Furthermore, when the polyurethane pouch is inflated, it deforms and its thickness is no longer uniform over its entire surface. Specifically, the inflation of the pouch, in order to obtain its functional shape in the stomach, leads to a wall thickness that is small at some points, and this may create regions of weakness and have negative consequences both for the balloon and for the patient.

### SUMMARY OF THE INVENTION

The objects assigned to the invention are therefore aimed at overcoming the various disadvantages listed hereinabove and at proposing a new method of manufacturing a flexible pouch that is easy, quick and economical to implement.

Another object of the invention is to propose a new method of manufacturing a flexible pouch that makes it possible to obtain a flexible pouch of conventional shape.

Another object of the invention is to propose a new method of manufacturing a flexible pouch that makes it possible to obtain a flexible pouch designed using a material that is known, available and can be employed using conventional methods.

It is another object of the invention to propose a new method of manufacturing a flexible pouch that makes it possible to obtain a flexible pouch that is designed with a material that guarantees the flexibility and mechanical strength of the flexible pouch.

It is another object of the invention to propose a new method of manufacturing a flexible pouch that involves manufacturing operations that are quick and easy to implement.

It is another object of the invention to propose a new method of manufacturing a flexible pouch that uses conventional and environmentally friendly operations.

It is another object of the invention to propose a new method of manufacturing a flexible pouch that makes it possible to obtain a flexible pouch that is strong and the thickness of which is particularly thin and uniform.

It is another object of the invention to propose a new method of manufacturing a flexible pouch that makes it possible to obtain a flexible pouch that can be used for treating morbid obesity in man.

It is another object of the invention to propose a new device for manufacturing a flexible pouch, the design of which is particularly simple, economical and easy to implement.

It is another object of the invention to propose a new device for manufacturing a flexible pouch that allows the manufacture of a flexible pouch that is of conventional shape and easy to use.

It is another object of the invention to propose a new device for manufacturing a flexible pouch that allows for quick, economical and environmentally friendly manufacture.

It is another object of the invention to propose a new device for manufacturing a flexible pouch that makes it possible to obtain a flexible pouch that is of small thickness and able to withstand mechanical stress.

It is another object of the invention to propose a new flexible pouch of simple and economical design.

The objects assigned to the invention are achieved using a method of manufacturing a flexible pouch, said method being characterized in that it comprises:
a step (a) of introducing at least one fluid or pulverulent material into a hollow mold comprising an interior wall, said interior wall defining a closed molding surface,
a step (b) of rotating the mold to spread said material against substantially all of the interior wall of the mold through a centrifugal effect.

The objects assigned to the invention are also achieved using a device for manufacturing a flexible pouch, said device being characterized in that it comprises:
a hollow mold comprising an interior wall, said interior wall defining a closed molding surface, said mold being intended to receive at least one fluid or pulverulent material,
a means of rotating the mold to spread said material against substantially all of the interior wall of the mold through a centrifugal effect.

The objects assigned to the invention are also achieved using a flexible pouch characterized in that it comprises a one-piece structure and a thickness substantially less than 500 μm.

### BRIEF DESCRIPTION OF THE DRAWINGS

Further objects and advantages of the invention will become better apparent from reading the description which follows, and with the aid of the attached drawings, given by way of purely nonlimiting illustration, in which:

FIG. 1 illustrates, in a partially exploded schematic perspective view, one preferred embodiment of a device for manufacturing a flexible pouch according to the invention.

FIG. 2 illustrates, in a schematic cross-sectional view, one preferred embodiment of a flexible pouch according to the invention.

### PREFERRED EMBODIMENT OF THE INVENTION

The invention relates to a method of manufacturing a flexible pouch 1 particularly one which has elastic properties allowing it to deform without damage when subjected to stress, particularly mechanical stress.

The present invention relates to any type of flexible pouch that can be used in varying fields such as, for example, the agri-foodstuffs industry for packaging and/or wrapping foodstuffs or the medical field for inserting the flexible pouch into implantable devices.

The method of manufacturing said flexible pouch 1 involves a step (a) of introducing at least one fluid or pulverulent material into a hollow mold 3 comprising an interior wall 3A, said interior wall 3A defining a closed molding surface. Advantageously, the mold 3 of the present invention has at least one axis of symmetry, and preferably at least two axes of symmetry, advantageously substantially perpendicular to one another. For preference, the mold 3 has a substantially spherical shape. In other words, the mold 3 intended to receive the material is of a shape substantially identical to that of a hollow sphere. Advantageously, the mold 3 has an inside diameter ranging between substantially 1 and 20 cm, preferably ranging substantially between 5 and 12 cm.

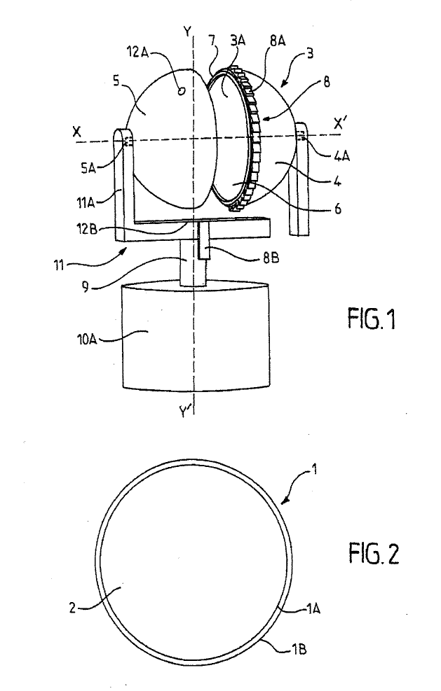

As illustrated in FIG. 1, the mold 3 comprises at least two shells 4 and 5 of substantially identical and hemispherical shape, said at least two shells 4, 5 being intended to be assembled so as to form the mold 3 of spherical shape and define a molding chamber 6. The two shells preferably have substantially identical hemispherical shapes and are arranged facing one another to allow them to be assembled precisely. They are held face to face without touching. The material is then tipped into the mold 3, precisely into at least one of the two shells 4, 5, which preferably lies in a horizontal position (FIG. 1 depicts the two shells 4, 5 in a vertical position), to prevent the material from running out of the mold 3.

Advantageously, in step (a), a quantity, preferably a precise and precalculated quantity, of material in fluid or pulverulent form, namely preferably in liquid, viscous or solid form, such as in the form of granules or powder for example, is introduced. The material in step (a) comprises at least a polymer material, and preferably an elastomeric material, that is to say a material capable of undergoing large deformations reversibly. For preference, the material in step (a) comprises at least a polyurethane. This may, for example, be a polyurethane in liquid form made up of isocyanate and polyol or a thermoplastic polyurethane in the form of granules, said granules being intended to liquefy in the presence of heat.

The material may also preferably comprise at least a thermoplastic, that is to say a plastic intended to deform or become fluidized in the presence of heat. It may, for example, be planned that use be made of polyethylene (PET), polyvinyl chloride (PVC), particularly plastisol PVC.

It is also conceivable, without departing from the scope of this invention, for the material of step (a) to comprise a mixture of several materials, advantageously chosen from among those described above. For example, the mixture could comprise granules of a polyurethane and of a PVC.

For preference, the material of the introduction step may comprise at least a silicone.

Once the material has been introduced into the mold 3, the method of manufacture preferably comprises an operation of pulling a vacuum said mold so that said at least two shells 4, 5 of the mold 3, brought closer together beforehand, become assembled in such a way as to form a closed mold 3. This operation is performed by introducing a needle, connected to a vacuum pump (not depicted in the figures) into one of the two septums 4A, 5A intended to be positioned at the poles of said shells. The septums 4A, 5A are preferably made of silicone. Using the vacuum pump, air is evacuated from the molding chamber 6 in which the pressure reaches a value substantially ranging between 1 and 20 mbar, and preferably of substantially 10 mbar. The pulling of the vacuum thus causes the two shells 4, 5 to become assembled.

For preference, the mold 3 comprises a seal 7 allowing the mold 3 to be sealed substantially against the material it contains. The seal 7 is advantageously positioned on at least one of the two shells 4, 5 at the zone of contact between the two shells 4, 5 at the time of their assembly, so as to guarantee sealed closure of the mold 3.

The method comprises, after the step (a) of introducing the material and the operation of closing the mold 3 using the vacuum, a step (b) of rotating the mold 3 in order to spread said material against substantially all of the interior wall 3A of the mold 3 through a centrifugal effect.

For preference, the rotation step comprises an operation of applying a flow of fluid to a first drive means 8 arranged at the periphery of said mold 3, so as to create a centrifugal rotational movement of said mold 3 about a first axis of rotation X-X′. The first axis of rotation X-X′ as illustrated in FIG. 1 preferably passes through the poles of the two shells 4, 5, specifically at their septums 4A, 5A.

The first drive means 8 preferably comprises vanes 8A positioned at the periphery of the mold 3. Advantageously, said vanes 8A are positioned all around the mold 3, substantially at the equatorial zone of said mold 3. In one preferred embodiment of the first drive means 8, the vanes 8A are preferably arranged at the periphery of one of the two shells 4, 5.

Alternatively, it is, however, conceivable for these vanes 8A to be arranged on both shells 4, 5, uniformly or otherwise at the periphery of said shells. For preference, said mold 3 comprises two series of vanes positioned around the entire perimeter of said shells 4, 5 at the equatorial zone at the periphery of the mold 3.

For preference, a flow of fluid is supplied to the first drive means 8, that is to say to the vanes 8A. Within the meaning of the invention, the fluid is a gas or a liquid, preferably under pressure so as to provide enough power to cause the mold 3 to rotate. Advantageously, a flow of compressed air is supplied to the vanes 8A using an air supply system 8B.

Advantageously, the rotation step (b) also involves an operation of rotating said mold 3 about a second axis of rotation Y-Y′ substantially perpendicular to the first axis X-X′, the speed at which the mold 3 rotates about the axis Y-Y′ being substantially synchronized with the speed at which the mold rotates about the axis X-X′. This method of manufacture in fact implements a second rotational movement of the mold 3 about the axis Y-Y′, as illustrated in FIG. 1. The mold 3 is rotated about the axis Y-Y′ advantageously using a second drive means 10, preferably using an electric motor 10A. The mold 3 is therefore simultaneously subjected to a first rotational movement about the axis X-X′ and to a second rotational movement about the axis Y-Y′.

The rotation as described hereinabove allows centrifugal force to be applied to the material introduced into the mold 3. Specifically, the compressed air and the motor are able to provide power such that the mold 3 is rotated through a centrifugal effect so that it can reach rotational speeds of between 1000 and 5000 revolutions per minute and preferably of more or less 3000 revolutions per minute. The speed at which the mold 3 rotates about the axis Y-Y′ is synchronized with that at which the mold rotates about the axis X-X′ so that the rotation speeds are identical.

Rotating the mold 3 through a centrifugal effect allows the material to be spread against substantially all of the interior wall 3A of the mold 3. In other words, the application of centrifugal force along two perpendicular axes of rotation to said material causes it to spread over the entire molding surface of the molding chamber 6, particularly by virtue of a pressing force which presses said material firmly against the interior wall 3A of the mold 3 and determines the thickness of the pouch obtained. Furthermore, this method makes it possible to achieve spreading of uniform and thin thickness over the entire surface of the interior wall 3A of the mold 3. This is particularly advantageous in obtaining a pouch of consistent and uniform thickness, with no differences in thickness, and therefore no zones of weakness and/or of excessive rigidity. Centrifuging during this method of manufacture also advantageously makes it possible to eliminate any bubbles of air or of gas that could be present in the material. The centrifugal spinning thus contributes to an effective “degassing” of the material to make it more uniform.

Advantageously, the rotation step (b) comprises a substep (b₁) of heating the material contained in said mold 3 in order to fluidize said material. While the material contained in the mold 3 is being subjected to centrifugal force, said mold 3 is heated so the material fluidizes, preferably into liquid form.

For preference, substep (b₁) comprises an operation of heating the mold 3 by supplying a heated fluid that allows the material to reach a temperature ranging substantially between 100 and 300° C., preferably ranging substantially between 150 and 220° C. Advantageously, hot air is introduced into the flow of compressed air used to rotate the mold 3 about the axis X-X′ so as to heat the mold 3 and to fluidize the material. Of course it is conceivable to use another method of heating, for example a supply of steam of hot water or of a hot liquid. For preference, the mold 3 is therefore made of a heat-resistant material, preferably aluminum. An aluminum mold 3 is particularly able to withstand the heat if hot compressed air is introduced.

Alternatively, it is also possible to resort to an operation of heating the mold by electromagnetic induction as this also makes it possible to obtain a material temperature substantially ranging between 100 and 300° C., preferably substantially ranging between 150 and 220° C. This method subjects said mold 3 to an electromagnetic field as it rotates. The mold 3 thus short-circuits the electromagnetic field thus causing the material of which the mold 3 is made to heat up and thus fluidizing the material it contains. Advantageously, said mold 3 is made of a material resistant to electromagnetic flux, preferably steel.

Advantageously, the interior wall 3A of the mold 3 is substantially smooth with no surface roughness and with a substantially mirror-polished finish. An interior wall 3A such as this, preferably obtained in steel, makes it possible to obtain a flexible pouch 1 that is perfectly smooth with no surface defects. This feature is particularly advantageous in instances in which the flexible pouch is to undergo a surface treatment at a subsequent stage in its manufacture, particularly a coating with a material, such as a metal or a ceramic for example. A very smooth exterior face 1B of the flexible pouch 1 in fact improves the attachment and retention of a coating material, particular of a metal.

The step (b₁) of heating the material is preferably needed if a solid material in the form of granules or powder is introduced into the mold, or to fluidize viscous materials. By contrast, this step (b₁) may prove not to be needed in case of certain materials which are supplied in liquid form.

After this step of fluidizing material, which is preferably done at the same time as the mold 3 is rotating, the rotation step (b) also advantageously comprises a substep (b₂) of solidifying the material into the form of a flexible pouch hugging the interior wall 3A of the mold 3, said solidification substep (b₂) comprising an operation of cooling the mold 3. Once the material has been spread uniformly over the entire surface 3A of the mold 3, the material is solidified in order to obtain a one-piece flexible pouch 1.

For preference, the solidification step (b₂) consists in a rapid cooling of the mold 3 which also allows the material that it contains to be cooled rapidly and set in the form of a flexible pouch 1. The cooling is advantageously performed by the expansion of iced gas, preferably in the form of iced compressed air the temperature of which is substantially below 0° C., advantageously substantially ranging between −20° C. and −30° C.

Alternatively, other cooling means may be envisioned:
expansion of a gas in the liquid phase, such as liquid nitrogen at a negative temperature for example,
expansion of liquid with, for example, cold water or water at ambient temperature,
expansion of a liquid in air.

For preference, the rate at which the flexible pouch 1 is cooled depends on the nature of the material of which said pouch is made and also on the desired use of said pouch. Thus, the cooling may vary between a slow rate at ambient temperature and a very rapid rate using thermal shock.

Following the solidification substep (b₂), the method of manufacture comprises an operation of halting the rotation of the mold 3.

Finally, after the solidification step (b₂) and the holding of the rotation, the method of manufacturing the flexible pouch 1 preferably comprises a step (c) of releasing the flexible pouch 1 from the mold and during which step the flexible pouch 1 is extracted from the mold 3, said mold-release step (c) comprising an operation of introducing a fluid between the flexible pouch 1 and the interior wall 3A of the mold 3 to make is easier to extract said pouch 1. Advantageously, the flexible pouch is released from the mold in a very simple way without the addition of a mold-release agent or any other contaminating additive. This step involving the supply of fluid is particularly quick and preserves the characteristics of the flexible pouch 1, particularly without adversely affecting the surface finish of said flexible pouch 1.

At the end of the mold-release step, there is thus obtained a flexible pouch 1 that can be used for the above applications. Said flexible pouch 1 has the advantage of being particularly thin. Indeed, its thickness is advantageously substantially below 500 μm, preferably substantially below 200 μm and is made as a single piece, that is to say as one piece with no opening. This method of centrifuging an elastomer in a closed spherical mold therefore makes it possible to obtain a one-piece flexible pouch of small thickness, such as a flexible pouch being of particular benefit in medical applications, particularly in the field of the treatment of morbid obesity in which it is necessary to have a pouch that is flexible and thin.

For preference, the flexible pouch 1 obtained with the abovementioned method is designed to form or to be inserted in an implantable device, said device being intended to be implanted in a human and/or animal body. Advantageously, said flexible pouch 1 is intended to contain an inflation fluid and to form or to be inserted in a device that can be implanted into the human and/or animal body. Within the meaning of the invention, an inflation fluid is made up of a liquid or a gas which is injected into the flexible pouch 1, specifically into the internal cavity 2 thereof, to allow the flexible pouch 1 to expand from a deflated configuration to an expanded inflated configuration of substantially spherical shape.

In one preferred embodiment of the invention, the flexible pouch 1 is intended to contain an inflation fluid and also to form or to be inserted in a gastric balloon, said balloon being intended to be implanted in the stomach of a patient with a view to reducing the volume of said stomach as part of a treatment for morbid obesity. The flexible pouch 1 has an internal face 1A in contact with the inflation fluid and an external face 1B intended to be in contact with the bodily fluid, preferably with the stomach environment. For such a use, the flexible pouch 1 preferably has a diameter substantially ranging between 5 and 12 cm and is obtained using the abovementioned method.

Advantageously, the flexible pouch 1 forming the balloon or the balloon comprising said flexible pouch 1 is introduced in deflated folded form, preferably via the natural passages (mouth and esophagus) into the stomach of a patient suffering from obesity, so as to reduce the amount of space available for the food ingested by the patient and thus assist with weight loss.

It is of course conceivable for the flexible pouch 1 to be used for any other application.

Independently of the foregoing, the present invention relates to a flexible pouch comprising a one-piece structure and a thickness substantially below 500 μm. For preference, the thickness of said pouch is substantially below 200 μm.

The present invention also relates to a device for manufacturing a flexible pouch 1. This device as illustrated in FIG. 1, comprises a hollow mold 3 comprising an interior wall 3A, said interior wall 3A defining a closed molding surface, said mold 3 being intended to receive at least one fluid or pulverulent material. The mold 3 and the material are substantially identical to those described in the foregoing. Thus, for preference, the hollow mold 3 comprises at least one axis of symmetry, and preferably two axes of symmetry. It is advantageously of substantially spherical shape and comprises at least two shells 4, 5 of substantially identical and hemispherical shape. The mold 3 advantageously comprises a diameter substantially ranging between 1 and 20 cm, preferably substantially ranging between 5 and 12 cm.

For preference, the manufacturing device of the present invention comprises a means (not illustrated) of closing the mold 3 comprising a pump designed to pull a vacuum inside said mold 3 so as to allow said at least two shells to be assembled. A needle is inserted into one of the septums 4A, 5A of the shells 4, 5 and is connected to a pump used to evacuate the air from the molding chamber 6 and thus close the mold 3.

The device also comprises a means 11 of rotating the mold 3 in order to spread said material over substantially all of the interior wall 3A of the mold through a centrifugal effect. For preference, the rotation means 11 allows the mold 3 to be kept in a stable position, particularly using a fork 11A intended to hold the two shells 4, 5 of the mold 3 when it is stationary or rotating. Specifically, the septums 4A, 5A of said shells 4, 5 are fixed to the fork 11A in a movable manner so as to allow the centrifugal rotational movement of the mold 3 and allow an operator to handle the mold, for example to remove one of said shells 4, 5. The septums 4A, 5A are preferably made of silicone and have a diameter substantially ranging between 5 and 20 mm, preferably of substantially 12 mm.

Advantageously, the rotation means 11 also comprises the first drive means 8, preferably vanes 8A, positioned at the periphery of the mold 3, in order to rotate said mold 3 when subjected to a flow of fluid. The first drive means 8, particularly comprises an air supply system 8B which allows compressed air to be supplied to the vanes 8A to cause them to turn.

For preference, the rotation means 11 comprises a second drive means 10 to rotate said mold 3 about an axis Y-Y′, said axis Y-Y′ being substantially perpendicular to the axis of rotation of X-X′ of the mold 3 driven by the first drive means 8. Advantageously, the second drive means 10 comprises a motor, preferably an electric motor 10A, as illustrated in FIG. 1.

The rotation means 11 further comprises a connection 9 between the fork 11A and the motor 10A, allowing the rotation means 11 to be joined together. The rotation means 11 thus constitutes a holding means intended to fix both said drive means 8, 10 and the mold 3.

According to one preferred embodiment, the rotation means 11 finally comprises a means 12 of slaving the speed at which the mold rotates about the axis Y-Y′ to the speed at which said mold 3 rotates about the axis X-X′. This slaving means 12 particularly allows the speed at which the mold 3 rotates about the axis Y-Y′ to be synchronized to that at which this same mold 3 rotates about the axis X-X′.

With a view to obtaining a pouch 1 of uniform thickness, it is appropriate to keep the speeds about the two axes substantially identical. To do this, use is made of a first sensor 12A positioned at the periphery of the mold 3. For each revolution of the mold 3 about the axis X-X′, the first sensor 12A, preferably a magnet, moves past a sensor 12B connected to an electronic processor which allows the speed about the axis Y-Y′ to be slaved precisely to that about the axis X-X′. The slaving means 12 therefore makes it possible to control the rotational speed about the axis Y-Y′ and to synchronize the two speeds. This has the benefit that the speed at which the mold 3 rotates about each of the axes of rotation X-X′ and Y-Y′ is uniform and identical. Alternatively, any other device that allows the speeds to be synchronized can be envisioned, notably using sensors of electrical, magnetic, luminous, optical nature, this list not being exhaustive.

Advantageously, the means 11 of rotating said mold 3 is designed to impart to the mold a rotational speed of between 1 000 and 5 000 revolutions per minute, preferably of between 2 000 and 4 000 revolutions per minute, and preferably of substantially 3 000 revolutions per minute. Such a speed causes centrifugal force to act on the material contained in the mold 3 and causes it to spread uniformly in a thin thickness over all of the surface of the interior wall 3A of the mold 3.

The device of the present invention makes it possible to implement a method of centrifugal spinning about two perpendicular axes in a closed spherical mold so as to obtain a flexible pouch of uniform and small, substantially below 500 μm, thickness.

### INDUSTRIAL APPLICATION

The invention finds an industrial application in the design and manufacture of flexible containers, particularly in the medical or agri-foodstuffs field.

1. A method of manufacturing a flexible pouch, said method comprising:
(a) introducing at least one fluid or pulverulent material into a hollow mold comprising an interior wall, said interior wall defining a closed molding surface; and
(b) rotating the mold to spread said material against substantially all of the interior wall of the mold through a centrifugal effect.

2. The method as claimed in claim 1, characterized in that the mold has at least one of: at least one axis of symmetry; or at least two axes of symmetry.

3. The method as claimed in claim 1, characterized in that the mold has a substantially spherical shape.

4. The method as claimed in claim 1, characterized in that the material in step-(a) comprises at least one of: a polymer material; or an elastomeric material.

5. The method as claimed in claim 4, characterized in that the material in (a) comprises at least a polyurethane.

6. The method as claimed in claim 4, characterized in that the material in (a) comprises at least a silicone.

7. The method as claimed in claim 1, characterized in that the mold comprises at least two shells of substantially identical and hemispherical shape, the at least two shells intended to be assembled in order to form a mold of spherical shape.

8. The method as claimed in claim 7 further comprising an operation of pulling a vacuum inside the mold so that the at least two shells of the mold become assembled in such a way as to form a closed mold.

9. The method as claimed in claim 1, characterized in that (b) comprises an operation of applying a flow of fluid to a first drive means arranged at the periphery of the mold, so as to create a centrifugal rotational movement of the mold about a first axis of rotation X-X′.

10. The method as claimed in claim 9, characterized in that (b) comprises an operation of rotating the mold (3) about a second axis of rotation Y-Y′ substantially perpendicular to the first axis X-X′, the speed at which the mold rotates about the axis Y-Y′ being substantially synchronized with the speed at which the mold rotates about the axis X-X′.

11. The method as claimed in claim 1, characterized in that (b) further comprises (b₁) heating material contained in the mold in order to fluidize the material.

12. The method as claimed in claim 11, characterized in that b₁ comprises an operation of heating the mold by supplying a heated fluid that allows the material to reach a temperature between at least one of: the range substantially between 100 and 300° C.; or the range substantially between 150 and 220° C.

13. The method as claimed in claim 1, characterized in that (b) comprises (b₂) solidifying the material into the form of a flexible pouch hugging the interior wall of the mold, said solidification (b₂) comprising an operation of cooling the mold.

14. The method as claimed in claim 1, characterized in that it comprises (c) releasing the flexible pouch from the mold and during the releasing, the flexible pouch is extracted from the mold, said mold-release (c) comprising an operation of introducing a fluid between the flexible pouch and the interior wall of the mold to make it easier to extract the pouch.

15. A device for manufacturing a flexible pouch, the device comprising:
a hollow mold comprising an interior wall, said interior wall defining a closed molding surface, said mold being intended to receive at least one fluid or pulverulent material,
a means of rotating the mold to spread said fluid or pulverulent material against substantially all of the interior wall of the mold through a centrifugal effect.

16. The manufacturing device as claimed in claim 15, characterized in that the hollow mold has one of: at least one axis of symmetry, or at least two axes of symmetry.

17. The manufacturing device as claimed in claim 15, characterized in that the mold is of substantially spherical shape.

18. The manufacturing device as claimed in claim 15, characterized in that the mold comprises at least two shells of substantially identical and hemispherical shape.

19. The manufacturing device as claimed in claim 18, characterized in that it comprises a means of closing the mold comprising a pump designed to pull a vacuum inside said mold so as to allow said at least two shells to be assembled.

20. The manufacturing device as claimed in claim 15, characterized in that the rotation means comprises a first drive means positioned at the periphery of the mold in order to rotate the mold when subjected to a flow of fluid.

21. The manufacturing device as claimed in claim 20, characterized in that the rotation means comprises a second drive means to rotate said mold about an axis Y-Y′, said axis Y-Y′ being substantially perpendicular to the axis of rotation X-X′ of the mold driven by the first drive means.

22. The manufacturing device as claimed in claim 21, characterized in that the rotation means comprises a means of slaving the speed at which the mold rotates about the axis Y-Y′ to the speed at which said mold rotates about the axis X-X′.

23. The manufacturing device as claimed in claim 15, characterized in that the means of rotating said mold is designed to impart to the mold at least one of:
(a) a rotational speed substantially between 1000 and 5000 revolutions per minute; or
(b) a rotational speed substantially between 2000 and 4000 revolutions per minute; or
(c) a rotational speed of more or less 3000 revolutions per minute.
